(19) United States
(12) Patent Application Publication
(10) Pub. No.: US 2021/0383445 A1
(43) Pub. Date: Dec. 9, 2021

(54) ONLINE CONNECTING OF SERVICE PROVIDERS

(71) Applicant: Joseph Nevo, Tel Aviv (IL)

(72) Inventor: Joseph Nevo, Tel Aviv (IL)

(21) Appl. No.: 17/284,404

(22) PCT Filed: Oct. 2, 2019
(86) PCT No.: PCT/IL2019/051078

§ 371 Date: Apr. 9, 2021

Related U.S. Application Data
(60) Provisional application No. 62/744,234, filed on Oct. 11, 2018.

(51) Int. Cl. G06Q 30/06; G06Q 10/06; G06Q 30/02

(52) U.S. Cl. CPC G06Q 30/0613; G06Q 50/10; G06Q 30/0257; G06Q 10/06311

(57) ABSTRACT

According to some aspects of the invention a computer-implemented method includes: receiving from a service consumer request parameters related to a required service; retrieving one or more service provider who complies with the request parameters from one or more service providers collection; and connecting between the service consumer and the service provider via an interactive session. According to some aspects of the invention a computerized apparatus includes a processor adapted to perform the steps specified in the above mentioned method. According to some aspects of the invention a computer program product includes a computer readable storage medium retaining program instructions, which program instructions when read by a processor, cause the processor to perform the above mentioned method. Some embodiments of the invention include estimating revenues of one or more service provider based on recorded data regarding transactions. Request parameters can be received by analyzing speech.

### TECHNICAL FIELD

The present disclosure relates to service provisioning in general, and to a system and method for connecting between service consumers and service providers in particular.

### BACKGROUND

For decades, a person in need of a service provider such as a plumber would leaf through a paper directory, search for providers in the relevant area, and start calling them. This was often a tedious process. Some providers went out of business since the directory was printed, others were unavailable, yet others did not provide the exact service, charged too high prices, or the like. Even further, the calling person had no consistent way to know whether the provider is professional and reliable or not.

When the Internet permeated the life of almost every person in the world, leafing through the directory was often replaced by browsing the Internet in search for a service provider. Although the search results are filtered by area, expertise, or the like, this still does not provide a satisfactory solution to the whole process.

The service consumer still has to write down the names and phone numbers, contact the service providers one by one, check their availability, compare their offering and price, or the like.

Another problem is the Jack of trusted recommendations. Even if a directory or a provider's site comprises recommendations, these may have been entered by the provider himself or someone on his or her behalf.

The terms “search”, “query”, and “request” may be used interchangeably hereinafter.

The terms “user”, and “consumer” may be used interchangeably hereinafter
The term “session” may refer inter alia to a phone conversation, a chat, a Voice over IP (VoIP) communication.

### SUMMARY

According to some aspects of the invention there is provided a computer-implemented method including:

receiving from a service consumer, request parameters related to a required service;
retrieving one or more service provider who complies with the request parameters from one or more service providers collection;
connecting between the service consumer and the service provider via an interactive session; and
connecting the service consumer and a service provider by an interactive session.

The above collection may include telephone numbers and retrieving one or more telephone number of one or more service provider. The service consumer may be able to dial numbers corresponding to request's parameters during a phone conversation. The method may include receiving a service consumer telephone number.

The method may include receiving verification regarding the service consumer telephone number. The verification may include calling the service consumer. The method may include monitoring the receiving of verification regarding the service consumer telephone number mentioned above. The monitoring may include recording the number of the requests made by the service consumer during predefined period. The method may include comparing the number to a predefined value. The threshold of the predefined value can be an upper permissible limit for the telephone number. In one example when the number reaches the threshold, engaging the service consumer mentioned above is subject to a managerial approval.

The method may include prompting the service consumer to provide feedback related to the first service provider or to the required service after the interactive session. The request parameters may be received by analyzing speech of the service consumer. Feedback may be received by analyzing speech of the service consumer. The method may include displaying to the user details of the first service provider. The method may include reading or utilizing a playback specifying details of the service provider.

The method may include connecting the service consumer with a second service provider if connecting the service consumer with the first service provider fails, or if no agreement was reached between the service consumer and the first service provider. The method may include recording data of transactions made between one or more service consumers and one or more service providers. The method may include estimating possible revenues for the service provider based on data regarding transactions made between one or more service consumers and one or more service providers. Estimating can be based on input pertaining to one or more service provider characterized according to the type of service, availability hours, activity zone, marketing activity, realized transactions, and service price. Estimating revenues can made in relation to incomes that would have been achieved theoretically during a period, for example when the service provider is unavailable or disqualified during that period.

The method may include estimating revenues by utilizing economic forecasts, general or specific to a particular service. The revenue estimation may involve using simulations.

The method may include prompting at least one human employee to monitor one or more interactive session with the one or more consumer. The monitoring may include verifying of speech analysis. The method may include a second interactive session between an employee and one or more service consumer.

The method may include scheduling the service. The method may include performing a first interactive session according to the scheduling. The method may include scheduling of contacting a consumer, for example according to previous communication. The scheduling may be according to availability one or more service provider.

The method may include ranking of a service provider that may be based on consumer's feedback, for example, via computerized interface or text message. The consumer may be able select the service provider according to the ranking. Revenue estimation may be in relation to the service provider's ranking.

A service request may be based on request parameters that may include the type of service being requested, consumer location, and service provider location. The method may include utilizing data input regarding the service provider such as payment compliance, contract compliance, and bonuses provided by the service provider such as free of charge service. A service provider may be offered to be included in a collection of service providers, for example after providing a bonus service.

The method may include utilizing feedback regarding a service consumers for example from service providers.

According to some aspects of the invention there is provided a computerized apparatus having a processor, the processor being adapted to perform the steps of:

receiving from a service consumer request parameters related to a required service;
retrieving one or more service provider who complies with the request parameters from one or more service providers collection;
connecting between the service consumer and the service provider via an interactive session; and
connecting the service consumer and a service provider by an interactive session.

According to some aspects of the invention there is provided a computer program product comprising a computer readable storage medium retaining program instructions, which program instructions when read by a processor, cause the processor to perform a method comprising:

receiving from a service consumer request parameters related to a required service; retrieving one or more service provider who complies with the request parameters from one or more service providers collection;
connecting between the service consumer and the service provider via an interactive session; and
connecting the service consumer and a service provider by an interactive session.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a screenshot of a service provider search application, in accordance with some exemplary embodiments of the subject matter, in which a user such as service consumer may indicate the required search (request) parameters and may be connected with a service provider from a list of suggested providers;

FIG. 2 shows a screenshot of a service provider search application in accordance with some exemplary embodiments of the subject matter, in which a user such as a service consumer is presented with relevant service providers;

FIG. 3 shows a screenshot of a service provider search application in accordance with some exemplary embodiments of the disclosed subject matter, in which a user may provide feedback about a service provider;

FIG. 4 shows a flowchart diagram in accordance with some exemplary embodiments of the disclosed subject matter of a method for connecting a service consumer and a service provider; and

FIG. 5 shows a block diagram of a system in accordance with some exemplary embodiments of the disclosed subject matter for connecting a service consumer and a service provider.

### DETAILED DESCRIPTION

One technical problem dealt with by the disclosed subject matter, is to provide a service consumer with an access to a service provider that is available, provides service in the relevant area, and is authentically recommended by other consumers.

Another technical problem dealt with by the disclosed subject matter is to provide quick access to the service provider, without having to record a list of telephone numbers, call them one by one and compare their offering.

One technical solution includes a computerized system and method that let a consumer use an internet or a mobile application or web page in order to submit a search or a query (request) for a relevant service provider. The user may search in accordance with predetermined parameters, such as type of service, service area, pricing, days or hours of service or the like. The user may also be able to enter free text which may be compared against free text or parameters associated with service providers. Some of the search parameters may be mandatory, such as availability and service areas, while others may be optional, such as price.

The system may then search for service providers that match the user search. The match may provide results indicating providers that fully comply with the mandatory search parameters. The results may be assigned a score in accordance with the degree of matching to the optional parameters.

The system may or may not present the search results to the consumer.

In addition, the system may connect the consumer to a service provider complying with the search result, for example the service provider that had the highest match with the consumer's search parameters. The provider's name or other details may or may not be displayed to the consumer. The connection may be created by initiating a phone conversation, a chat, a Voice over IP (VoIP) communication, or the like. If the service provider answers, the provider and consumer are connected and can engage in the provisioning of the service. Otherwise the system may continue to the next provider in the list, and so on until a connection is formed. If after the communication the engagement does not work out, the consumer can indicate this to the system, and be connected to further providers.

After the engagement was carried out, or at a later time, the consumer may be contacted and requested to provide authentic feedback about the provider with whom he eventually engaged. The feedback may be in the form of a total grade, closed questions related to specific parameters in which the user has to grade the provider, free text, or the like. The grades and feedback may then be used by the system in choosing the service providers to be recommended to future consumers. Thus, the system may give precedence to providers that consistently receive high scores.

One technical effect of utilizing the disclosed subject matter is the provisioning of a method and system for providing consumers with quick access to service providers. The access is provided immediately in response to the user specifying the requested service, area or other parameters, by automatically connecting the consumer to one or more providers. The user may then be prompted to provide feedback or a recommendation related to the service provider, which feedback may be used in decision of which service provider should be connected to future consumers.

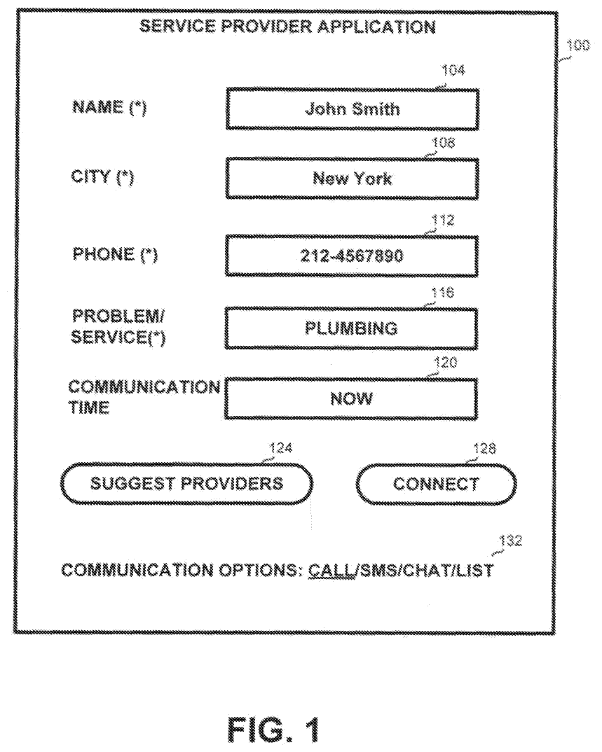

Referring now to FIG. 1, showing a user interface of an application for searching a service provider in accordance with certain parameters, in accordance with some exemplary embodiments of the subject matter.

It will be appreciated that searching for a service provider in accordance with the disclosure may be performed using a web page, a dedicated application, an applet, an application installed on a mobile device such as a smartphone, or the like.

FIG. 1 shows user interface 100 displaying a screen for searching a service provider. User interface 100 may be displayed to a user, such as a service consumer, after the user have identified or registered with the system, or independently of such registration.

User interface 100 comprises a number of mandatory fields related to the consumer, which may be initially populated with details provided while registering. Such fields may be used when searching for a service for another person. The fields may include name 104, city 108 and phone 112.

User interface 100 may further include an indication of the problem or required service 116 which may be mandatory, and preferred communication time 120 (for interactive communication), any or both of which may be mandatory.

Some of the fields, such as city 108, problem 116 or preferred communication time 120 may be entered using free text or selected from a predetermined list, while others may be entered using free text.

The user may enter additional text or comment 122, for example a comment to be sent to a service provider together with the service request.

The user may then press “Suggest Providers” button 124 in order to be shown list of providers that provide the required service in the relevant area that are available and optionally have at least a predetermined satisfaction grade level.

The user may alternatively press “Connect” button 128 in order to be connected to a service provider. Connection may be carried out in accordance with the selection at field 132, such as call, short message text, chat, or the like.

The user may then be connected to the service provider, for example a service provider complying with the request and having the highest satisfaction grade within the system.

If connection is not established, or the user indicated that no engagement took place, the system may form communication between the user and another available and complying service provider.

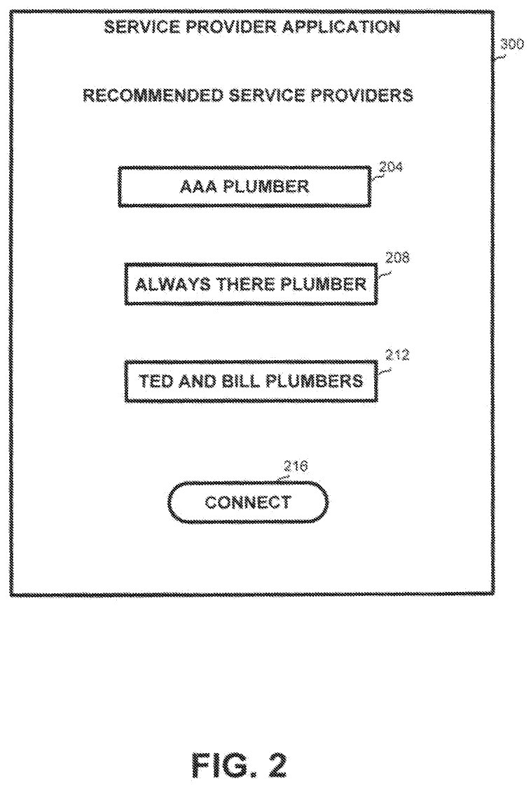

Referring now to FIG. 2, showing a screenshot of a service provider search application, in which a user is presented with relevant service providers, in accordance with some exemplary embodiments of the subject matter. User interface 200 may show a list of one or more service providers available at the required time and complying with the request, such as AAA Plumber 204, Always There Plumbers 208 and Ted and Bill Plumbers 212. The user may then select one of them and press “Connect” button 216 to be connected to the provider as described above.

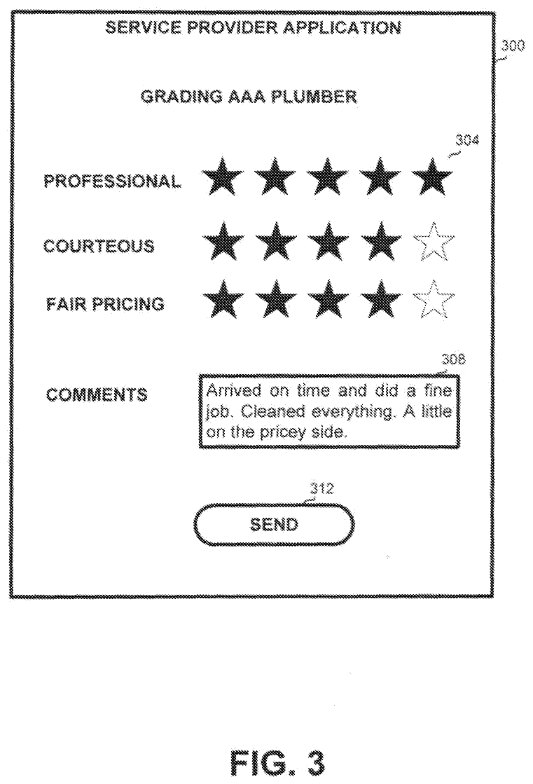

Referring now to FIG. 3, showing a screenshot of user interface 300 of a service provider search application, in which a user may provide feedback about a service provider, in accordance with some exemplary embodiments of the disclosed subject matter; and

It will be appreciated that this prompting for a feedback may be performed a while, for example between one day and one month after the service consumer and a service provider had been connected by the system. The consumer may be asked if they eventually engaged. If they did, the consumer may be prompted to enter data as detailed below. If they did not engage, the system may prompt the consumer to detail why not.

User interface 300 may provide the user with an area 304 in which he can grade the service provider with whom he or she had engaged according to a number of predetermined parameters, such as whether the provider is professional courteous, fairly priced the service, or the like.

The user may also enter free text at area 308 for freely describing his or her experience with the service provider.

The user may then press “Send” button 312, to send the review to the system, such that the grading will be taken into account the next time this service provider is considered. [0051] In some embodiments, the reviews about a service provider may be shown to a user when the service provider is found to be available and complies with the user requirements.

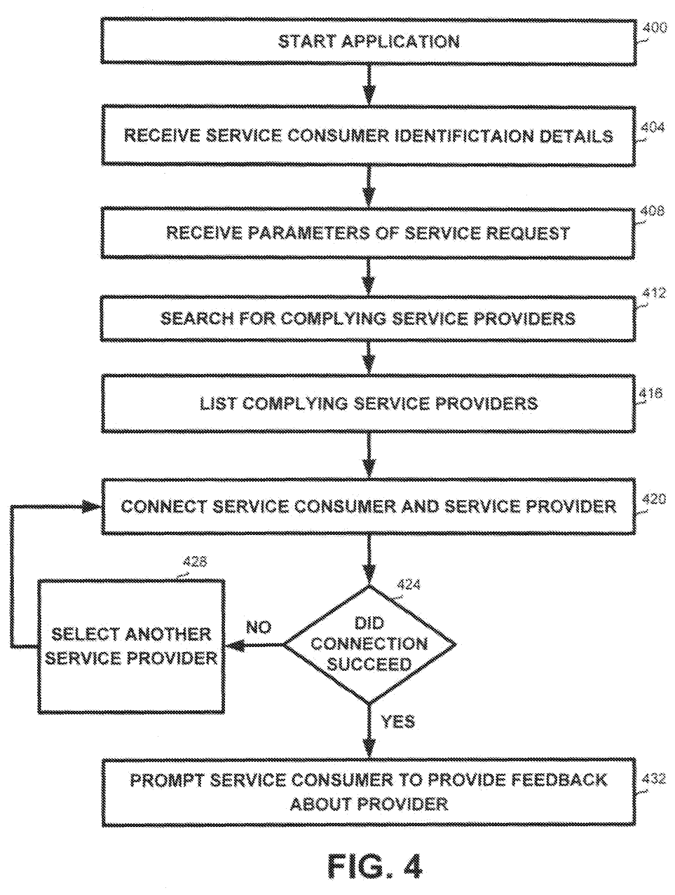

Referring now to FIG. 4, showing a flowchart diagram of a method for connecting a service consumer and a service provider, in accordance with some exemplary embodiments of the disclosed subject matter.

On step 400 a session may be initiated, on a web page, a web application, an applet, or the like, on any computerized platform, such as a laptop computer, a desktop computer, a mobile phone, or the like.

Optionally, an opening screen may be displayed to the user, which may require identification details, such as name or nickname, password, phone number, or the like.

On step 404, the details related to the service consumer, as may have been entered using the opening screen may be received by the system.

On step 408 parameters related to the required service providers may be received from the user. The necessary parameters may be service type, such as plumber, and geographical area. Further parameters may also be provided, such as exact type of service, price range, or the like. Some parameters may be required while others may be optional, or may be used for assigning a score. Each parameter may be selected from a predetermined list, or entered as typed text, entered as speech and interpreted using voice recognition, or the like. In some embodiments, the service provider type may comprise multiple types, such as washing machines seller and washing machines technician.

On step 412 the system may search for service provider entries in a database or another collection, which comply with the request parameters. The required parameters may be searched as is, while others may be compromised. For example, the service provider type may not be compromised, but the price may be compromised. The free text entries, whether entered as text or as speech may be searched using any matching technique, using for example string similarity matching. The system may assign a score for each service provider based upon their match to the consumer request, recommendations the provider has received in the past, a combination thereof, or the like. If the request comprises a range of values, the match to these values may also be taken into account when calculating the score.

On step 416, the retrieved list of service providers may or may not be displayed to the consumer.

On step 420, the service consumer and the first service provider in the list, whether the list was displayed to the user or not, or any other service provider in the list, may be connected or engaged in a possibly interactive session, for example by initiating a two way phone call, a VoIP call, a chat session, or the like. The service consumer may be contacted using the details received on step 404 or prompted for, prior to the connection being established.

On step 424 it is determined whether connection was indeed established for example if there was an interaction between a consumer and the provider of at least a predetermined length. Additionally or alternatively, the service consumer may indicate whether they reached an agreement about providing the service, as a result of the interaction.

If no engagement took place or no agreement was reached, then on step 428 another service provider may be selected from the list, and step 424 may be repeated for the other service provider.

If the connection was successful, then on step 432, which may occur a period of time later, such as one day to a few weeks, the consumer may be prompted to enter feedback related to the service provider. The feedback may contain multiple choice questions, grading questions, from which the consumer has to select one or more options, and/or the consumer may enter free text.

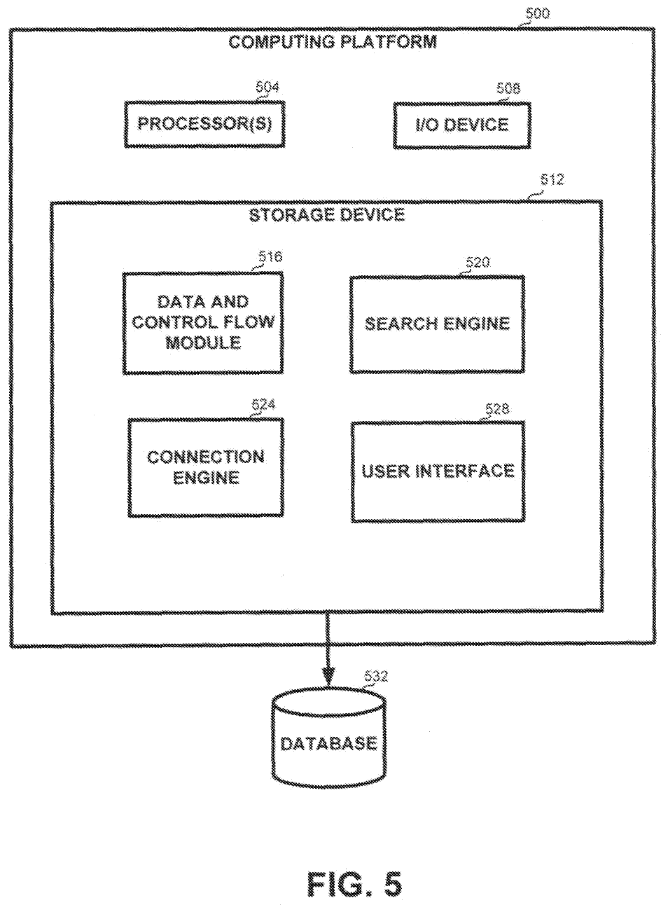

Referring now to FIG. 5, showing a block diagram of an apparatus in accordance with some exemplary embodiments of the disclosed subject matter. The apparatus comprises computing platform 500, such as mobile device, a laptop computer, a desktop computer, or the like.

In some exemplary embodiments, computing platform 500 may comprise a processor 504. Processor 504 may be a Central Processing Unit (CPU), a microprocessor, an electronic circuit, an Integrated Circuit (IC) or the like. Processor 404 may be utilized to perform computations required by computing platform 400 or any of it subcomponents.

In some exemplary embodiments of the disclosed subject matter, computing platform 500 may comprise an Input/Output (I/O) device 508. I/O device 508 may be utilized to provide output to and receive input from a user, such as visual or audio input and output devices, for example a display, a keyboard, a touch screen, a speaker or a microphone.

In some exemplary embodiments, computing platform 500 may comprise a storage device 516. Storage device 516 may be a hard disk drive, a Flash disk, a Random Access Memory (RAM), a memory chip, or the like. In some exemplary embodiments, storage device 516 may retain program code operative to cause processor 504 to perform acts associated with any of the subcomponents of computing platform 500. Storage device 516 may also store service consumer details, service provider details, or the like. Alternatively or additionally, storage device 516 may be in communication with database 532 which may also store service consumer details, service provider details or other related data.

Storage device 516 may comprise one or more components as detailed below, implemented as executables, libraries, static libraries, functions, or any other executable components. However, any one or more of the components may be executed by any other computing platform, which may be in communication with computing platform 500 via any communication channel such as the Internet.

Storage device 516 may comprise data and control flow manager for controlling the flow of the application, for example receiving details from the consumer, receiving the request parameters, connecting the consumer and provider, prompting the user for feedback or the like.

Storage device 516 may comprise search engine 520 for forming queries and sending the queries to database 532 or another storage device, receiving the responses and optionally sorting them, or the like.

Storage device 516 may comprise connection engine 524, such as a Public Switched Telephone Network (PSTN) interface, or similar to that, for forming connection between two subscribers such as the service consumer and the service provider. Alternatively, connection engine 524 may be adapted to connect the consumer and provider in a chat, a VoIP conversation, or the like.

Storage device 516 may comprise user interface 528 for receiving information and displaying options to the service consumer, such as an opening screen or menu for entering personal data, a query screen or menu for specifying the required service, a screen or menu for displaying the complying available providers, or the like.

User interface 528 may be visual and operated by a keyboard, a touch screen or the like. Alternatively or additionally, user interface 528 may be voice activated and operated, such that the options are read to the consumer and the consumer voice is captured and analyzed for receiving query parameters, entering feedback or the like.

Storage device 516 may comprise further components, such as voice activation modules comprising speech to text and/or text to speech engines, or the like.

The present invention may be a system, an apparatus, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any. type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer-implemented method comprising:
receiving from a service consumer request parameters related to a required service;
assigning a match score for at least one service provider from at least one service providers collection, said score is in accordance with the degree of matching of said service provider to said request parameters;
retrieving at least one service provider with the highest match score from said collection; and
immediately connecting between said service consumer and said service provider via an interactive session,
wherein said request parameters comprises location and availability of said service provider,
wherein said connecting is formed automatically.

2-4. (canceled)

5. The method of claim 1, comprising verification regarding said service consumer.

6. The method of claim 2, wherein said verification comprises calling said service consumer.

7-11. (canceled)

12. The method of claim 1, further comprising prompting said consumer to provide feedback related to said service provider or to the required service after said interactive session.

13. The method of claim 1, wherein the request parameters are received by analyzing speech of said service consumer.

14-24. (canceled)

25. The method of claim 1 comprising prompting at least one human employee to monitor said interactive session.

26-27. (canceled)

28. The method of claim 1 comprising scheduling said service.

29. The method of claim 28 comprising performing said first interactive session according to said scheduling.

30. The method of claim 1, comprising scheduling said connecting.

31-32. (canceled)

33. The method of claim 1 comprising ranking said at least service provider.

34. (canceled)

35. The method of claim 33, wherein said ranking is according to said feedback related to said service provider.

36. The method of claim 33, further comprising assigning a match score for at least one service provider from at least one service providers collection, said score is in accordance with said ranking.

37-43. (canceled)

44. A computerized apparatus having a processor, said processor being adapted to perform the steps of:
assigning a match score for at least one service provider from at least one service providers collection, said score is in accordance with the degree of matching of said service provider to said request parameters;
receiving from a service consumer request parameters related to a required service;
retrieving at least one service provider with the highest match score from said collection; and
immediately connecting between the service consumer and the service provider via an interactive session,
wherein said request parameters comprises location and availability of said service provider,
wherein said connecting is formed automatically.

45. A computer program product comprising a computer readable storage medium retaining program instructions, which program instructions when read by a processor, cause the processor to perform a method comprising:
assigning a match score for at least one service provider from at least one service providers collection, said score is in accordance with the degree of matching of said service provider to said request parameters;
receiving from a service consumer request parameters related to a required service;
retrieving at least one service provider with the highest match score from said collection; and
immediately connecting between the service consumer and the service provider via an interactive session,
wherein said request parameters comprises location and availability of said service provider,
wherein said connecting is formed automatically.

46. The method of claim 1, wherein said parameters comprise visual input.

47. The method of claim 28, wherein said scheduling comprises user selecting at least one service provider from a list of service providers that are available at the user required time, wherein said service providers from the list complying with said request parameters.

48. The method of claim 30, wherein said scheduling of said connecting comprises entering free text or selecting required time from a predetermined list.

49. The method of claim 1, wherein in case that said connecting is not established, at least one attempt is made automatically to connect said service consumer with a service provider having a next highest match score from said collection, wherein said attempt is repeated until said connecting is established.

50. The method of claim 1, wherein in case that no agreement is reached, at least one attempt is made automatically to connect said service consumer with a service provider having a next highest match score from said collection, wherein said attempt is repeated until said agreement is reached.

51. The method of claim 1, wherein session selected from the group consisting of text messages a web page, a web application, an applet, a phone conversation, a chat, a Voice over IP and combinations thereof.
